(19) United States
(12) Patent Application Publication
(10) Pub. No.: US 2012/0071137 A1
(43) Pub. Date: Mar. 22, 2012

(54) SYSTEM AND METHOD OF RECORDING, MANAGING, AND PRESENTING VOICE GREETINGS

(76) Inventor: ABEL BISRAT, Alexandria, VA (US)

(21) Appl. No.: 13/235,617

(22) Filed: Sep. 19, 2011

Related U.S. Application Data
(60) Provisional application No. 61/383,902, filed on Sep. 17, 2010.

(51) Int. Cl. H04W 4/12

(52) U.S. Cl. 455/413

(57) ABSTRACT

According to one exemplary embodiment, a method and system for recording, organizing, and presenting one or more voice greetings is disclosed. The method or system can be implemented using software running on any of a variety of computing devices. The method and system can facilitate the recording and organizing of one or more voice greetings and can determine when and to whom a greeting can be presented, based on at least one of date, time, and identity of a contact.

### CROSS REFERENCE

This application claims the benefit of priority, under 37 C.F.R. §120, to U.S. Provisional Patent Application No.: 61/383,902, filed on Sep. 17, 2011, the disclosure of which is incorporated by reference herein in its entirety.

### BACKGROUND

In modern voicemail systems, generally only one outgoing voice greeting is available at a time. Because this voice greeting is difficult to record and change, often only one generic outgoing greeting is used, even though a call could be missed for a variety of reasons, for example meetings, classes, work, time at the gym, vacations, or any of a number of other activities. Some of these activities also repeat on a regular basis. While it would be convenient and useful to have a voice greeting that reflected the reason a call was likely missed, manually erasing and re-recording an outgoing greeting daily or weekly is often difficult and cumbersome.

In addition, some voice greetings may be appropriate for family and friends, but inappropriate for, for example, business and professional contacts. A generic outgoing voice message used for all contacts can often be too formal for one of these groups and at the same time be too casual for another. Most voicemail systems do not allow for differentiation between groups. If any customization of voice greeting content and availability is offered at all, it is often difficult to use and manage.

### SUMMARY

According to one exemplary embodiment, a method and system for recording, organizing, and presenting one or more voice greetings is disclosed. The method or system can be implemented using software running on a computing device. The method and system can facilitate the recording and organizing of one or more voice greetings and can determine when and to whom a greeting can be presented, based on at least one of date, time, and identity of a contact.

### BRIEF DESCRIPTION OF THE DRAWINGS

Advantages of embodiments of the present invention will be apparent from the following detailed description of the exemplary embodiments. The following detailed description should be considered in conjunction with the accompanying figures in which:

FIG. 1 is a view of an exemplary embodiment of a default screen,

FIG. 2 is a view of an exemplary embodiment of a new message screen,

FIG. 3 is a view of an exemplary embodiment of an automatic settings screen,

FIG. 3A is a view of an exemplary embodiment of an automatic settings screen,

FIG. 4 is a view of an exemplary embodiment of a settings screen.

### DETAILED DESCRIPTION

Aspects of the present invention are disclosed in the following description and related figures directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many of the embodiments described herein are described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, “a computer configured to” perform the described action.

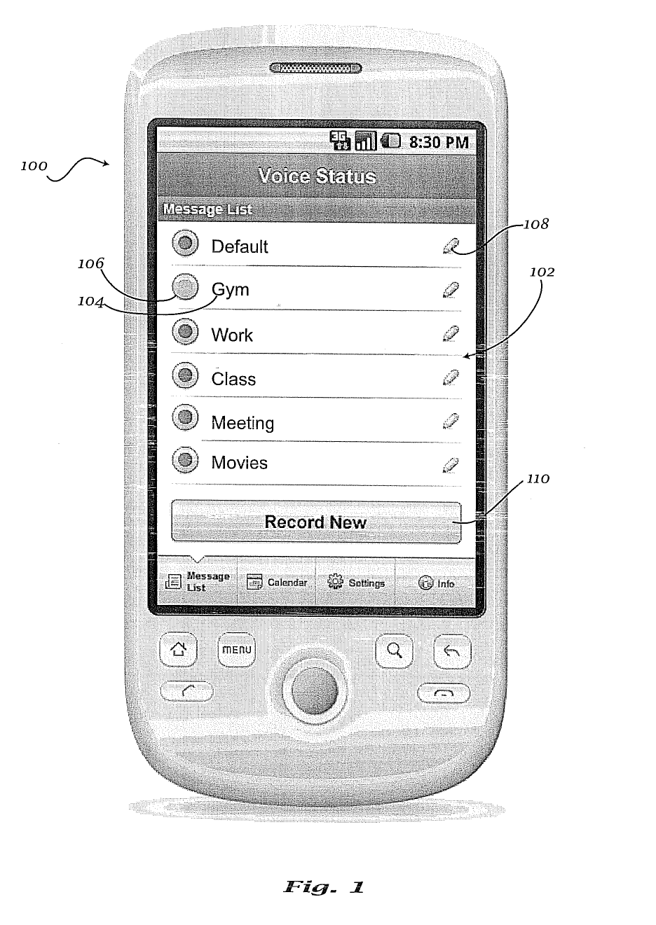

Generally referring to FIGS. 1-4, a method or system for recording, managing, and presenting one or more voice greetings is disclosed. The method or system can be implemented using any software running on a computing device, for example a cellular telephone running a mobile operating system, such as, Android Operating System, iOS, Windows OS, Web OS or Blackberry OS. The method or system can alternatively be implemented on any other cellular telephone running any other operating system, or any other computing device, as desired. The embodiments described herein describe a touch screen embodiment of the method and system, but it is envisioned that the system may also be implemented with external means, such as a keyboard, mouse, scroll ball or other similar means.

FIG. 1 illustrates an exemplary embodiment of a default screen 100 for the system. The default screen 100 can contain a list of messages 102. Each entry in the list 102 can contain a name 104 for the message, an indicator light 106, and an edit button 108. The active/inactive status of a message can be modified by tapping message name 104. The color of indicator lights such as indicator light 106 can be used to indicate whether an individual message is active or inactive. If a message is active, indicator light 106 can be colored, for example, green. If a message is inactive, indicator light 106 can be, for example, dimmed or colored red. If a message is set as a default, indicator light 106 can be colored, for example blue. In other exemplary embodiments, any other desired color scheme can be used for indicator light 106. Messages which are inactive can appear in the lower portion of list 102. Messages which are active can appear in the upper portion of list 102. One or more attributes of a message can be modified by tapping edit button 108, which can bring up new message screen 200. A new message can be recorded by tapping record new button 110, which can also bring up new message screen 200.

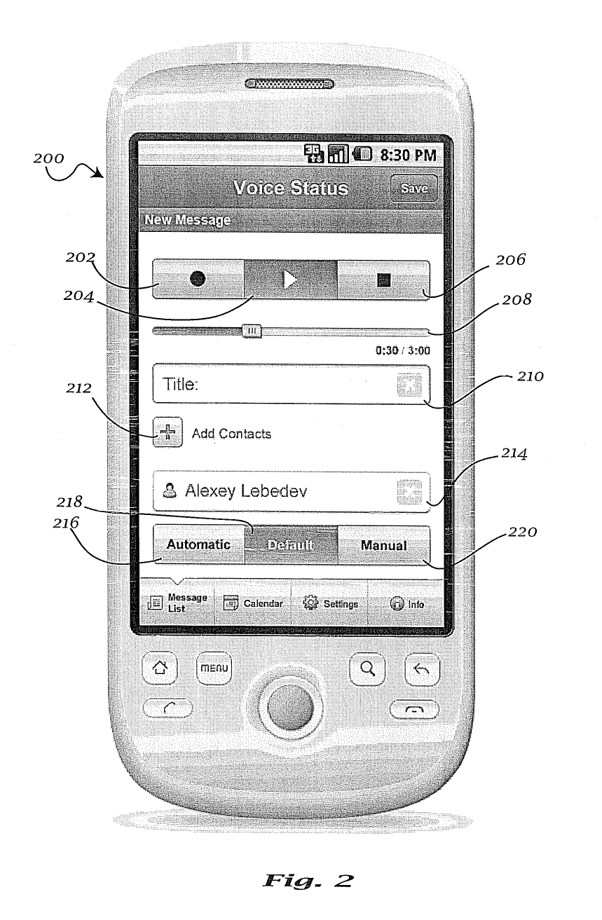

FIG. 2 illustrates an exemplary embodiment of a new message screen 200. New message screen 200 can contain one or more playback buttons, which can include record button 202, play button 204, and stop button 206. A message recording can be started by tapping record button 202. Once record button 202 is tapped, the system can record a message for any predetermined length of time, for example three minutes. The recording can be stopped at any desired time by tapping stop button 206. The message can be played back by tapping start button 204. Playback bar 208 can indicate the length of the message as well as the current playback time location. A specific playback time location can be selected by tapping at any point along playback bar 208.

Still referring to FIG. 2, a message can be named using title window 210. Tapping title window 210 can bring up a keyboard, and any desired text can be entered. Further, a user can determine the contacts to whom a message will be presented to using add contacts button 212. Tapping add contacts button 212 can bring up a list of contacts saved on a computing device. Selecting a contact from the list of contacts can place that contact into selected contacts list 214. If list 214 is selected for a specific message, the message may be presented to only the contacts that appear in selected contacts list 214. If no contacts appear in selected contacts list 214, the message may be presented to all contacts.

The message can be classified using one or more classification buttons, which can include automatic button 216, default button 218, and manual button 220, as seen on FIG. 2. The message can be assigned default status by tapping default button 218. If a message has default status it can be presented to contacts when no manual or automatic message is active. The message can be assigned manual status by tapping manual button 220. If a message has been assigned manual status it can be presented to contacts when it is assigned active status on the default screen. Alternatively, a message can be assigned automatic status by tapping automatic button 216. If a message has automatic status it can be automatically presented to contacts at desired dates or times. Desired dates or times for messages with automatic status can be selected using automatic settings screen 300. Once a message has been recorded, a title has been entered, any desired contacts have been saved, and a classification has been set, the system may return to default screen 100.

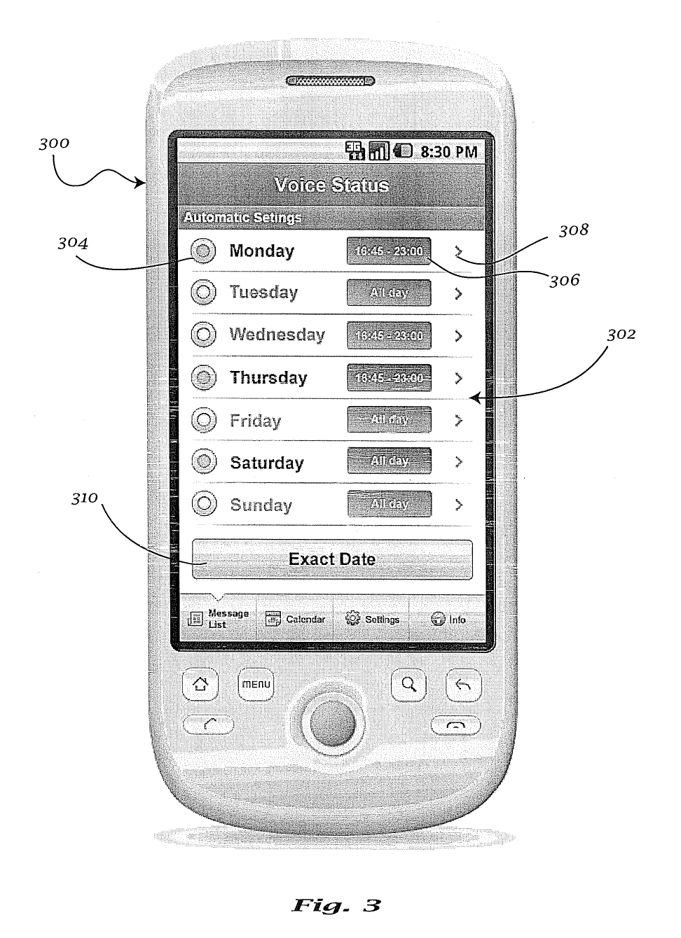

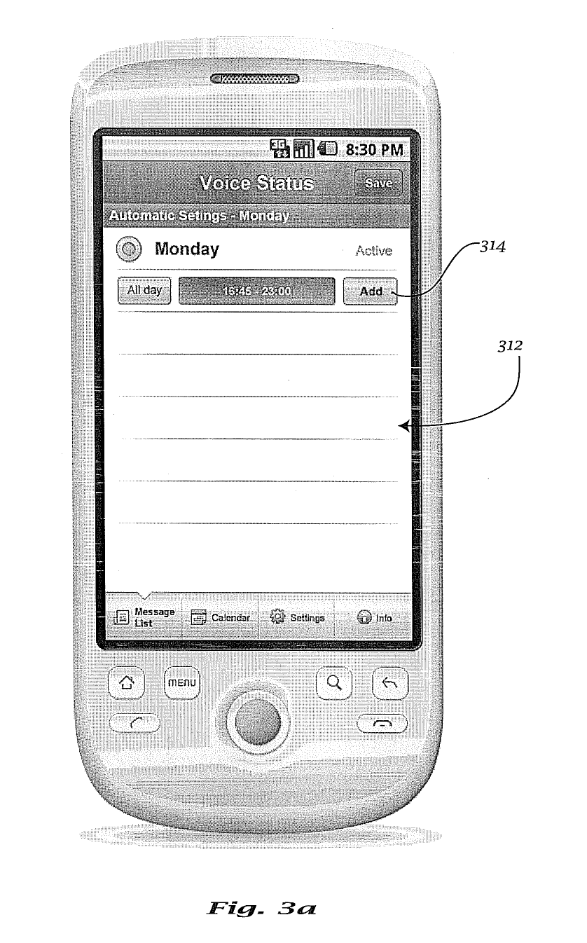

FIG. 3 illustrates an exemplary embodiment of an automatic settings screen 300. Automatic settings screen 300 can enable a user to control when a particular message is presented, for example, based on at least one of date or time. Automatic settings screen 300 can contain a day list 302, which can list days of the week. A day can be selected by tapping a day control button, for example day control button 304. When a day is selected, the default time for the message to be presented can be set to all day. Alternatively, a specific time for the message to be presented can be set using the time window associated with that day, for example, time window 306. Tapping time window 306 can bring up a keyboard, which may enable a start time and finish time to be entered. Additional time can be added using an additional time button associated with that day, for example additional time button 308. Tapping an additional time button, for example additional time button 308, can bring up an additional time screen associated with that day, for example additional time screen 312 shown on FIG. 3A. Tapping add time button 314 can bring up new time windows, which may be similar to time window 306 and may allow additional times to be specified. It is further envisioned that a message can be presented on only one specific date or time, on a non-repeating basis, using exact date button 310. Tapping exact date button 310 can bring up a calendar on which at least one of a date or time can be specified.

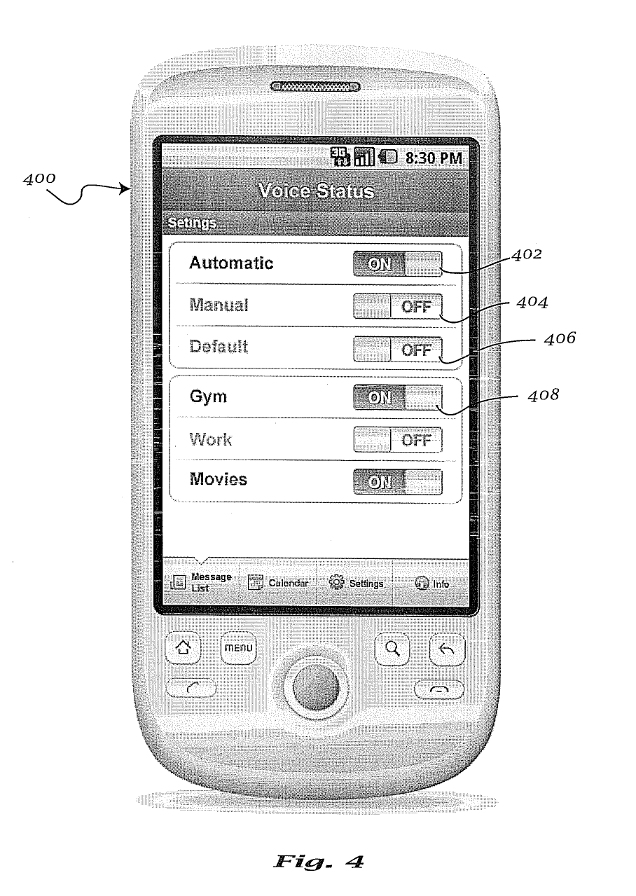

FIG. 4 shows an exemplary embodiment of a settings screen 400. Settings screen 400 can contain master control buttons such as automatic messages master control button 402, manual messages master control button 404, and default messages master control button 406. Automatic messages master control button 402 can control whether any automatic messages are presented. Manual messages master control button 404 can control whether any manual messages are presented. Default messages master control button 406 can control whether any default messages are presented. Settings screen 400 can also contain control buttons for individual messages, for example individual message control button 408. Individual message control button 408 can control whether the message with which it is associated is presented.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A machine implemented method comprising:
recording voicemail data from a user;
receiving user inputs, wherein said user inputs set parameters for when recording voicemail data is communicated,
storing said user inputs and said voicemail data in a computer readable medium;
utilizing a mobile operating system to retrieve the voicemail data from the computer readable medium;
communicating a specific voicemail data based on said user inputs.

2. The method of claim 1, wherein said voicemail data may be audio recordings.

3. The method of claim 2, wherein said audio recordings may be recorded and played back through an audio input and output system.

4. The method of claim 1, wherein said user inputs may be specific dates or times.

5. The method of claim 4, wherein said user inputs may be received from various computer programs and applications.

6. The method of claim 4, wherein the dates or times is a single instance or a repeating event.

7. The method of claim 1, wherein the user inputs are input via a touch-activated screen.

8. The method of claim 1, wherein the mobile operating system is an Android Operating System.

9. A voicemail system comprising:
a user interface for inputting input data and voicemail data;
memory for storing a plurality of input data and voicemail data;
a processor coupled to the memory for receiving the input and voicemail data and communicating said voicemail data based on input data.

10. The voicemail system of claim 9, wherein the voicemail data is an audio recording.

11. The voicemail system of claim 10, further comprising an audio input and output system.

12. The voicemail system of claim 9, wherein the input data is at least one contacts, dates or times.

13. The voicemail system of claim 9, wherein the input data is received from various computer programs and applications.

14. The voicemail system of claim 9, wherein the user interface is a touch-activated screen.

15. The voicemail system of claim 9, wherein the processor is also utilized for a mobile operating system.

16. The voicemail system of claim 15, wherein the mobile operating system is an Android Operating System.

17. A computer readable medium storing a computer program that when executed causes a computer to perform the steps of:
displaying to the user a computer representation of a list of options, wherein the list of options may include contacts, dates and times;
for each selection of an event and while continuing to display a representation of the list of options, displaying to the user a second list of options for the user to select a certain voicemail to become associated with said first event;
storing said user selected events and associated voicemails;
communicating the selected voicemails when a voicemail message is required based on the events and associated emails stored within the program.

18. The computer program of claim 17, wherein the computer program is compatible with a mobile operating system.

19. The computer program of claim 17, wherein a certain voicemail is associated with more than one event.
